(19) United States
(12) Patent Application Publication
(10) Pub. No.: US 2014/0002893 A1
(43) Pub. Date: Jan. 2, 2014

(54) FIBER AMPLIFIER SYSTEM

(71) Applicants: Dirk Nodop, Jena (DE); Jens Limpert, Jena (DE); Andreas Tuennermann, Weimar (DE)

(72) Inventors: Dirk Nodop, Jena (DE); Jens Limpert, Jena (DE); Andreas Tuennermann, Weimar (DE)

(73) Assignees: FRIEDRICH-SCHILLER-UNIVERSITAET JENA, Jena (DE); FRAUNHOFER-GESELLSCHAFT ZUR FOERDERUNG DER ANGEWANDTEN FORSCHUNG E.V., Muenchen (DE)

(21) Appl. No.: 13/990,873

(22) PCT Filed: Nov. 25, 2011
(86) PCT No.: PCT/EP2011/005935

§ 371 Date: Sep. 9, 2013

(30) Foreign Application Priority Data
Dec. 1, 2010 (DE) 102010052907.9

(51) Int. Cl. H01S 3/067

(52) U.S. Cl. CPC H01S 3/06754
USPC 359/341.1

(57) ABSTRACT

The invention relates to a fiber amplifier system for amplifying and emitting pulsed radiation, having a master source (1) which emits pulsed output radiation, and at least one amplifier stage (4), which is arranged after the master source (1) in the direction of radiation, and which amplifies the output radiation. The aim of the invention is to provide a fiber amplifier system for amplifying and emitting pulsed radiation which avoids stimulated Brillouin scattering as effectively as possible and at the same time can be produced simply and inexpensively. To this end, the output radiation emitted by the master source (1) is broadband and is generated substantially by means of spontaneous emission.

The invention relates to a fiber amplifier system for amplifying and emitting pulsed radiation, having a master source, which emits pulsed output radiation, and at least one amplifier stage, which is arranged after the master source in the direction of radiation, and which amplifies the output radiation.

Fiber amplifier systems of this kind, so-called Master Oscillator Power Amplifier (MOPA) systems with flexible pulse forms within a range of nanoseconds, represent attractive resources both for industrial and scientific applications. Amongst others, interesting systems are those in which all parameters such as repetition rate, pulse form, pulse energy, and pulse duration can be influenced by means of a master source. It opens up an extremely broad field of application. In micro-material machining, laser parameters can be adapted to a given material to be machined or to the desired machining technique, for example drilling, welding, ablating or trepanning. Moreover, fiber-based systems become particularly interesting, because they can be set-up in an integrated-optical and adjustment-free manner, and are able to render high average performance. Even on generating EUV radiation, a fiber amplifier system of the initially described kind is of great interest.

Usually, a fiber-based oscillator power amplifier (MOPA) system is comprised of a master source and several successively arranged amplifier stages based on rare-earth doped fibers. Between the master source and the successive amplifier stage and/or between successive amplifier stages, it is possible to arrange a filtering element which, for example, is a spectral filter or a polarization filter.

To be able to generate arbitrary pulse forms, in most cases a fiber-coupled Fabry-Perot laser diode is applied as master source in prior art. Such a Fabry-Perot laser diode disposes of a nearly linear power output characteristic accompanied by sufficiently fast rise and decay times. By the aid of a function generator and driver electronics, any arbitrary pulse form can thus be generated.

A problematic issue with laser diodes of this type is the development of extremely narrow-band, isolated lines in the emission spectrum if the laser diode is controlled with a slowly rising pulse. These narrow-band lines are individual longitudinal modes which with a rising pump current reach in isolated form over to the laser threshold and dominate the spectrum on account of gain competition. By means of the successive amplifier stage, these longitudinal modes are amplified to pulses with a very high spectral intensity. From a certain pulse peak rate on, it leads to a stimulated Brillouin scattering (SBS). Since the stimulated Brillouin scattering runs contrary to the propagation direction of the laser pulse, the backscattered portion gets lost for the output pulse. The resulting output pulse is hereby distorted in its temporal shape. Likewise, the backscattered portion may reach such high rates that may entail damage to the amplifier system. Hence, the stimulated Brillouin scattering is the limiting factor on increasing the pulse energy in fiber-based MOPA systems.

A stimulated Brillouin scattering occurs as a non-linear effect if inelastic interactions occur between photons and acoustic phonons of the fiber material. The energy of the acoustic phonons reduces the energy of the pump photons which leads to a shifting of optical frequencies of the output radiation in the backscattered portion. An amplification of the Brillouin scattering rises exponentially with the length of the fiber, whereas the amplification coefficient depends on the material of the fiber, fiber geometry, and fiber temperature. The critical performance P_{cr} at which a Brillouin scattering starts in a glass fiber can be assessed by applying the following formula:

P_{cr}=˜21 A_{eff}(1+Δν_{S}/Δν_{Br})/g_{Br}L_{eff}

where A_{eff} is the effective mode area, Δν_{S} is the bandwidth of the output radiation, Δν_{Br} is the bandwidth of the stimulated Brillouin scattering, g_{Br} is the amplification coefficient, and L_{eff} is the effective length of the fiber.

The equation shows that the critical performance at which stimulated Brillouin scattering starts to occur, is proportionate to the ratio of the bandwidth of the output radiation Δν_{S} and the bandwidth of the stimulated Brillouin scattering Δν_{Br}. The bandwidth Δν_{Br} depends on the service life of the acoustic phonons, and with quartz glass and a wavelength of roughly 1 μm it amounts to approx. 10-20 MHz. The spectral bandwidth Δν_{S} of a spectrally transformation-limited

Gauss pulse having a pulse duration of for example 50 ns amounts to approximately 1.8 MHz. This value ranges well below the bandwidth of the stimulated Brillouin scattering Δν_{Br} and thus it leads to a very low critical performance rate P_{cr}. In contrast therewith, a spectral bandwidth of the output radiation Δν_{S} in the amount of 1 THz—which roughly corresponds to 4 nm bandwidth with 1 μm wavelength—would comparably increase the critical performance rate P_{cr} by approximately 5 orders of magnitude. The advantage of utilizing a spectrally broad-band master source for fiber amplifiers with a high performance rate thus becomes evident.

Therefore, master sources are applied in state-of-the-art technology, whose bandwidth of the signal to be amplified is chosen to be so high that the critical performance rate becomes sufficiently high to suppress stimulated Brillouin scattering for the relevant performance parameters.

But problems arise for applications with a fiber-based MOPA system because in most cases a pulsed Fabry-Perot laser diode is utilized as master source, the spectral bandwidth of which depends on the pulse form, pulse duration, and repetition rate. As has been described hereinabove, extremely narrow-band, isolated lines occur in the emission spectrum with a rising pump current, thus causing stimulated Brillouin scattering.

Furthermore, approaches have been made in prior art to modify, for example, the geometry of the fiber, material composition, temperature or mechanical tension within the fiber in such a way that the resonance condition changes simultaneously over the overall length of the fiber. This prevents a development of dominating modes, because each partial section of the fiber amplifies another frequency and thus the amplification relative to a certain frequency remains low. The increase thus achieved concerning the threshold for stimulated Brillouin scattering is nevertheless insufficient for numerous applications.

Another prior art method provides for imprinting a temporally modulated phase onto the signal of the master source by means of a phase modulator, said modulated phase leading to side bands in the frequency domain and thus to an effective broadening of the spectrum. A phase modulator in combination with an existing pulsed master source, however, is very costly.

Consequently, prior art concepts have a disadvantage in that they are constructively costly and expensive and/or fail to achieve a sufficient increase in the threshold for Brillouin scattering.

Now, therefore, it is the object of the present invention to provide a fiber amplifier system for amplifying and emitting pulsed radiation that avoids stimulated Brillouin scattering as effectively as possible and at the same time can be produced simply and inexpensively.

To achieve this object, the present invention based on a fiber amplifier system of the initially described kind proposes that the output radiation emitted from the master source is broadband and is generated substantially by spontaneous emission.

Broadband within the sense of the present invention is an output radiation which emits not only a few wavelengths. With a central wavelength of 1045 nm, this applies, for example, to a spectral bandwidth of roughly 4 nm (=roughly 1 THz). Particularly optimal would be a spectral bandwidth in a range of 10 nm (=roughly 2.5 THz).

It is an essential feature of the present invention that the output radiation is generated by means of spontaneous emission. Those problems known from prior art due to individual longitudinal modes of high intensity which cause stimulated Brillouin scattering within the amplifier stages are thus avoided.

Advantageously the master source is an LED whose end facets have an antireflective coating. Components of this type are designated hereinafter as super-luminescence diodes (SLD). They represent low-cost and robust components which dispose of a nearly linear power output characteristic and generate a broadband spectrum. Moreover, super-luminescence diodes dispose of the coupling-in properties of a laser. In contrast with a laser, however, they are not comprised of a dedicated resonator and consequently they have a low coherence length. Thus, a development of extremely narrow-band longitudinal modes in the emission spectrum is effectively prevented.

A super-luminescence diode practically is constructively identical to a Fabry-Perot diode. However, whereas a Fabry-Perot diode utilizes the Fresnel reflection of the end facet of the active semiconductor layer system in order to form a resonator with a highly reflecting layer on the opposite facet, the end facets with a super-luminescence diode are provided with an antireflective coating or tilted versus the propagation direction of the laser pulse. This configuration leads to a suppression of optical feedback and thus it prevents the outset of laser emissions with the described formation of individual longitudinal modes. On account of the high small-signal amplification in the active semiconductor layer system of the super-luminescence diode, spontaneous emission is amplified and because of the waveguide properties of the semiconductor layer system it exits from the super-luminescence diode as a diffraction-limited beam, whose spectrum is only determined by the amplification bandwidth of the semiconductor layer system and the effect of gain narrowing. Because of the anisotropic structure of the semiconductor layer system, the emitted light is linearly polarized and can be coupled into a polarization-maintaining single mode fiber.

For application as a master source in a MOPA system, it is for example feasible to employ a super-luminescence diode with a spectral bandwidth of 10 nm with a central wavelength of 1045 nm. This corresponds to a bandwidth of approx. 2.5 THz. The relevant peak rate of 150 mW ranges within the same order of magnitude of comparable Fabry-Perot laser diodes. The shape of the spectrum is virtually independent of pulse duration, pulse form, and repetition rate. With the so-called spectral bandwidth of approx. 2.5 THz, an adequate increase in the Brillouin scattering threshold is in any case ensured.

Very simple fiber-based MOPA systems can be realized by applying the present invention. Because of the extremely small finesse of the super-luminescence diode, the photons service life is practically equal to the duration of a single pass through the active range of the super-luminescence diode so that there is no resonator dynamics due to the non-existing feedback. In combination with fast control electronics, arbitrary pulse forms ranging from sub-nanoseconds to continuous wave operation are thus possible, whereby a super-luminescence diode in a temporal range represents a highly dynamic synthesizer.

Eligible as diode within the scope of the present invention are all construction styles of light-emitting semiconductor structures such as edge emitters, surface emitters, trapezoidal structures, gain-guided and index-guided structures. Likewise, both direct and indirect semiconductors may be applied.

Advantageously the end facets of the super-luminescence diode, as outlined hereinabove, are provided with an antireflective coating. Alternatively, the surface normal of the end facets may have an angle versus the direction of radiation that deviates from 0°. Reflection is hereby suppressed so that an outset of laser emission is prevented. Thus merely a spontaneous emission will occur within the diode whereby coherence length is short.

In accordance with the invention, a filtrating element may be arranged upstream to and/or downstream of the at least one amplifier stage. It is preferably a spectral filter or a polarization filter. Particularly eligible for use are band pass filters which adapt the spectrum in the desired bandwidth and/or which filtrate non-desired amplified spontaneous emission. Moreover eligible for use are polarization filters and optical isolators. All filters can be designed to suit specific application requirements and be tunable, respectively.

Alternatively, the fiber amplifier system can be so designed that the amplifier stage is passed through by the radiation several times in order to increase the amplifying factor. This is advantageously achieved by arranging a circulator upstream to the amplifier stage, with a spectral grating being allocated to said circulator downstream of the amplifier stage in the direction of radiation. The spectral grating may in particular be a fiber Bragg grating, a long-periodic grating or a tunable grating. This version comprising a circulator and a spectral grating has an advantage in that the amplifier stage works in a double pass mode, i.e. it is passed through twice and thus it supplies substantially more amplification. Moreover, by the aid of the spectral grating, the optical spectrum can be influenced to suit specific application requirements.

It is of advantage that one amplifier stage, several amplifier stages or all amplifier stages are waveguides. Fiber-optical amplifier stages lend themselves suitable in particular because they can be optimally integrated into a fiber-based amplifier system, thus reducing the otherwise usually needed adjustments substantially.

Alternatively, the amplifier stage or several or all amplifier stages may be a volume-optical element. Volume-optical elements may work with media in solid, liquid or gaseous statuses which are pumped optically, electrically or chemically.

Apart from the inventive fiber amplifier system, the invention relates to a method for amplifying and emitting pulsed laser radiation in which the pulsed output radiation from a master source is amplified by means of at least one amplifier stage, with the master source emitting a broadband output radiation generated by means of spontaneous emission.

In particular, the fiber amplifier system can be so configured that it is optimized for non-linear frequency conversion.

Practical examples of the present invention are elucidated more precisely in the following by means of figures, where:

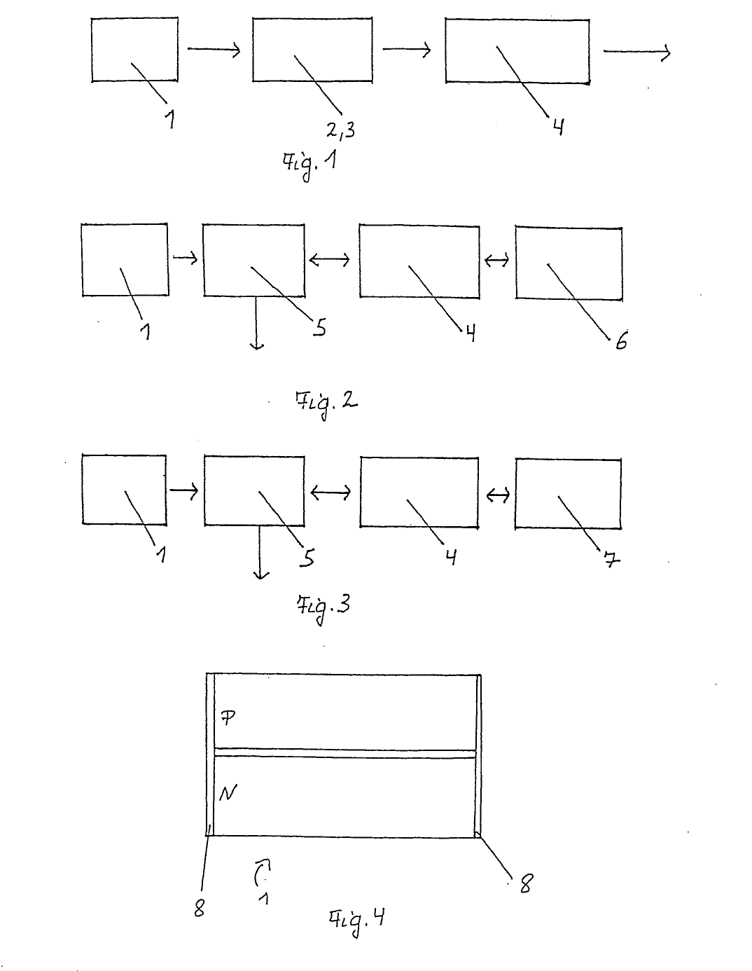

FIG. 1: shows the inventive fiber amplifier system with an optical filter,

FIG. 2: shows the inventive fiber amplifying system with an optical circulator and a fiber Bragg grating,

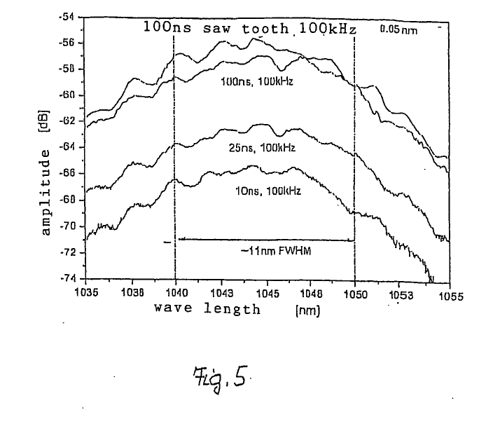

FIG. 3: shows the inventive fiber amplifier system with an optical circulator and an external, tunable, optical grating,

FIG. 4: shows the setup of an inventively applied super-luminescence diode,

FIG. 5: shows spectra of the output radiation of a super-luminescence diode with different pulse forms, repetition rates and pulse durations.

The fiber amplifier system according to FIG. 1 is comprised of a super-luminescence diode 1 as master source, a polarization filter 2 and/or a spectral filter 3 and an optical amplifier 4. Such a setup could be realized completely, for example, by means of fiber-integrated isolators 2, a band pass filter 3, and a fiber amplifier 4. This setup can be expanded by several successively arranged stages of isolators 2/band pass filters 3, and optical amplifiers (4) (not shown here). With the band pass filters 3, the spectrum can be adapted in the desired bandwidth and a non-desired amplified spontaneous emission can be filtrated.

The setup according to FIG. 2 is comprised of a super-luminescence diode 1, a circulator 5, a fiber amplifier 4, and a fiber Bragg grating 6. The alternative embodiment according to FIG. 3 also shows a setup comprised of a super-luminescence diode 1, a circulator 5, and a fiber amplifier 4, with a tunable grating 7 being arranged downstream of the fiber amplifier 4. The embodiments according to FIGS. 2 and 3 have an advantage in that the fiber amplifier is passed through twice by the propagating radiation so that the resulting amplification of the propagating radiation is noticeably increased.

FIG. 4 shows the semiconductor layer system of a super-luminescence diode 1. The two end facets 8 of the super-luminescence diode 1 are coated with an antireflective layer (reflection degree 0%).

FIG. 5 shows an emission spectrum of an inventive super-luminescence diode 1 with different pulse forms, repetition rates, and pulse durations. As can be seen, the shape of the emission spectrum, and more particularly the spectral bandwidth, is virtually independent of the pulse duration, pulse form, and repetition rate of the super-luminescence diode 1.

The arrangement in accordance with FIG. 1 works in such a manner that the super-luminescence diode 1 emits, for example, output pulses with an emission spectrum according to FIG. 5. The pulses have a spectral bandwidth of approximately 11 nm (FWHM) with a central wavelength of 1045 nm. The peak rate amounts to, for example, 150 mW. Pulse duration, pulse form, and repetition rate can be freely chosen without this having any impact on the pulse spectrum. Since the super-luminescence diode 1 according to FIG. 4 in contrast with a Fabry-Perot laser diode has no reflective end facets, but is provided, for example, with an antireflective coating, the end facets 8 of the super-luminescence diode 1 do not constitute a resonator. Owing to the missing optical feedback, an initiation of laser emissions is prevented so that individual longitudinal modes cannot develop. On account of the high small signal amplification in the active semiconductor layer system of the super-luminescence diode 1, spontaneous emission is intensified and because of the waveguide properties of the semiconductor layer system it leaves the super-luminescence diode 1 as a diffraction-limited beam, the spectrum of which is only determined by the amplification bandwidth of the semiconductor layer system and by the gain narrowing effect. Because of the anisotropic structure of the semiconductor layer system, the light emitted by the super-luminescence diode 1 is linearly polarized and can be coupled into a polarization-maintaining single-mode fiber (not shown here). Subsequently, the light is adapted by the aid of the isolators 2 and/or band pass filters 3 in relation to spectral bandwidth or polarization status. Likewise, any non-desired amplified spontaneous emission can be filtered. With the downstream arranged optical amplifier 4, the optical pulses are amplified, without this leading to a development of stimulated Brillouin scattering due to single longitudinal modes with high spectral intensity. Having passed the optical amplifier 4, the amplified radiation may optionally pass through further polarization filters 2/spectral filters 3 and optical amplifiers 4 arranged one behind the other.

The version of the fiber amplifier system according to FIGS. 2 and 3 works in such a manner that the radiation emitted by the super-luminescence diode 1 at first passes through a circulator 5, by the aid of which the emitted radiation enters into a fiber amplifier 4. From there, the amplified radiation gets to a spectral grating 6, 7 which has a spectral filter function and which reflects the to incident radiation back into the fiber amplifier 4. During this process, the radiation is amplified once more within the fiber amplifier 4, and then it passes through the circulator 5, leaving it via a separate exit so that the two-fold amplified radiation is not reflected back into the super-luminescence diode 1. The spectral grating 6, 7 may optionally be a fiber Bragg grating 6 (according to FIG. 2) or a tunable grating 7 (according to FIG. 3).

1. A fiber amplifier system for amplifying and emitting pulsed radiation, having a master source (1) which emits pulsed output radiation, and at least one amplifier stage (4), which is arranged after the master source (1) in the direction of radiation, and which amplifies the output,
wherein
the output radiation emitted from the master source (1) is broadband and generated substantially by means of spontaneous emission.

2. The fiber amplifier system according to claim 1, wherein the master source (1) is an LED, namely a super-luminescence diode (SLD), the end facets (8) of which have an antireflective coating.

3. The fiber amplifier system according to claim 1, wherein the master source (1) is an LED, wherein the surface normal of at least one end facet (8) has an angle versus the direction of radiation that deviates from 0°.

4. The fiber amplifier system according to claim 1, wherein a filtrating element is arranged upstream to and/or downstream of the amplifier stage (4).

5. The fiber amplifier system according to claim 4, wherein the filtrating element is a spectral filter (3) or a polarization filter (2).

6. The fiber amplifier system according to claim 1, wherein the amplifier stage (4) is several times passed through by the radiation.

7. The fiber amplifier system according to claim 6, wherein a circulator (5) is arranged upstream to the amplifier stage (4), with a spectral grating (6, 7) being allocated to said circulator in the direction of radiation downstream of the amplifier stage (4).

8. A The fiber amplifier system according to claim 7, wherein the spectral grating (6, 7) is a fiber Bragg grating (6) or a tunable grating (7).

9. The fiber amplifier system according to claim 1, wherein the amplifier stage (4) is a waveguide.

10. The fiber amplifier system according to claim 1, wherein the amplifier stage (4) is a volume-optical element.

11. A method for amplifying and emitting pulsed laser radiation, wherein pulsed output radiation from a master source (1) is amplified by means of at least one amplifier stage (4),
wherein
the output radiation emitted by the master source (1) is broadband and is generated substantially by means of spontaneous emission.

12. Use of a fiber amplifier system according to claim 1 for non-linear frequency conversion.
